(19) United States
(12) Patent Application Publication
(10) Pub. No.: US 2002/0119289 A1
(43) Pub. Date: Aug. 29, 2002

(54) Gloss reduction of plastics by media blasting

(76) Inventors: Ben E. Czajka, Centerville, OH (US); Mary K. Heilers, Galloway, OH (US); Donna J. Hawes, Hagerstown, IN (US)

Correspondence Address: KATHRYN A. MARRA, ESQ., DELPHI TECHNOLOGIES, INC., Legal Staff, P.O. Box 5052, Mail Code: 480-414-420, Troy, MI, 48007-5052, US

(21) Appl. No.: 09/954,286

(22) Filed: Sep. 17, 2001

Related U.S. Application Data
(60) Provisional application No. 60/271,977, filed on Feb. 27, 2001.

(51) Int. Cl. B32B 3/00; B29C 47/00; B29C 47/04; B29C 59/00

(52) U.S. Cl. 428/156; 264/162; 264/173.18; 264/211.12; 264/284

(57) ABSTRACT

An unpainted thermoplastic material is provided. The unpainted thermoplastic material includes a microscopically deformed surface having a gloss less than about 3.0. A method of reducing gloss of a formed thermoplastic material is also provided. The method includes impacting a surface of the formed thermoplastic material with a particulate so as to effect light reflecting properties of the surface. The surface is microscopically deformed such that the light reflecting properties provide a gloss of less than about 3.0. The particulate is selected from the group consisting of baking powder, ice, sand, glass beads, and subliming particles.

### RELATED APPLICATION

This application claims benefit of commonly owned and assigned U.S. provisional patent application, serial No. 60/271,977 filed on Feb. 27, 2001, the contents of which are incorporated herein by reference thereto.

### TECHNICAL FIELD

This application relates to gloss reduction of plastics by media blasting. More specifically, this application relates to methods of manufacturing low gloss polymers.

### BACKGROUND

Thermoplastic polymer compositions have been employed extensively in the fabrication of thermoformed or vacuum formed skin or sheathing for automotive interior surfaces, such as instrument panel trims, door panels, air bag covers, roof liners, and seat covers. For many years, films and laminates of polyvinyl chloride (PVC) resins found widespread utility. Although performance of PVC materials has been regarded as adequate, certain inherent disadvantages have been associated with the use of PVC. Large amounts of plasticizers are required to be used to enhance the flexibility, surface texture and low temperature properties of PVC materials. High temperatures, to which interiors of automobiles often are subjected, results in the migration of the plasticizers to the surface of the PVC films, causing a film layer to form on window surfaces and an eventual brittleness in the PVC itself Environmental concerns regarding PVC include the difficulty of its disposal and its incompatibility with other plastics in the recycling of automotive scrap. Such disadvantages have led to the development of various other thermoplastic polymers to replace polyvinyl chloride for these applications.

Thermoplastic elastomers (TPEs) have become an important class of polymeric compositions for production of durable plastic components through conventional extrusion or injection molding thermoplastic forming processes. Typically, TPEs are a blend of thermoplastic polymer and a cured elastomer (rubber). When the elastomer component of a TPE is cured during blending with the thermoplastic polymer component, the TPE also commonly is referred to as a thermoplastic polymer “alloy”. These alloy compositions largely have replaced polyvinyl chloride for the fabrication of many articles in the automotive field. These alloy compositions provide many of the low and high temperature resistance properties that are desired in automotive interior applications.

Thermoplastic olefin (TPO) compositions are a class of thermoplastic elastomers based predominantly, or even wholly, on olefin polymers. A typical olefin polymer may be a blend or reactor blend of a polyolefin plastic, such as a polypropylene polymer, with an olefinic copolymer elastomer (OCE), such as an ethylene-propylene rubber (EPM) or an ethylene-propylene-diene rubber (EPDM). The polyolefin plastic imparts a temperature resistance and rigidity characteristic of that thermoplastic resin to the TPO, while the olefin copolymer imparts properties to the TPO characteristic of the elastomer, notably, flexibility, resilience, and toughness

### SUMMARY

An unpainted thermoplastic material is provided. The unpainted thermoplastic material includes a microscopically deformed surface having a gloss less than about 3.0 as measured using polyolefin plaques at a 60° scale.

A method of reducing gloss of a formed thermoplastic material is also provided. The method includes impacting a surface of the formed thermoplastic material with a particulate so as to effect light reflecting properties of the surface. The surface is microscopically deformed such that the light reflecting properties provide a gloss of less than about 3.0 as measured using polyolefin plaques at a 60° scale. The particulate is selected from the group consisting of baking powder, ice, sand, glass beads, and subliming particles.

Additionally, a method of making a plastic article is provided. The method includes forming an extrudate of thermoplastic material, forming the plastic article from the extrudate, and microscopically deforming a surface of the plastic article to reduce a gloss level of the surface.

An instrument panel section is also provided. The instrument panel section includes a skin adhered to a layer of foam. The skin is an unpainted formed thermoplastic material having a first surface. The first surface has a gloss less than about 3.0 as measured using polyolefin plaques at a 60° scale. The layer of foam is adhered to a second surface of skin, opposite the first surface.

The above-described and other features and advantages of the present invention will be appreciated and understood by those skilled in the art from the following detailed description, drawings, and appended claims.

### BRIEF DESCRIPTION OF THE DRAWINGS

FIG. 1 is a schematic of a typical polymer skin manufacturing process including a painting process;

FIG. 2 is a diagram of veil glare caused by high gloss instrument panels;

FIG. 3 is a schematic of an alternate typical polymer skin manufacturing process;

FIG. 4 is a schematic of an exemplary embodiment of a media blasting process;

FIG. 5 is a photomicrograph of the surface of an unpainted skin at 60×magnification prior media blasting;

FIG. 6 is a photomicrograph of the surface of the unpainted skin of FIG. 5 after media blasting; and

FIG. 7 is a cross section of an exemplary embodiment of an instrument panel section.

### DESCRIPTION OF THE PREFERRED EMBODIMENT

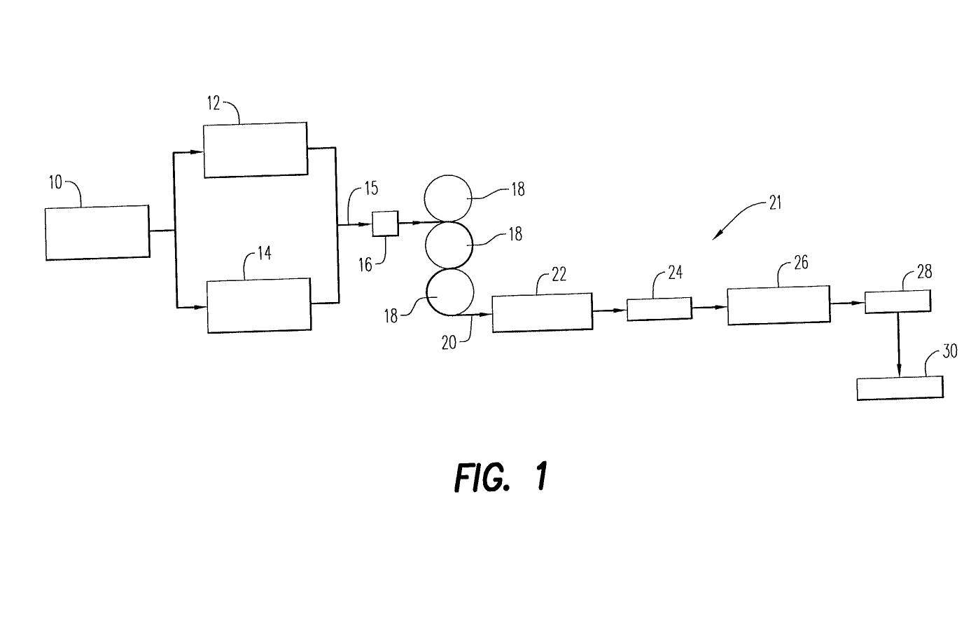

Referring now to the Figures and in particular to FIG. 1, a schematic of a typical manufacturing process is illustrated. In this process, components of the desired TPE composition are melt blended and pelletized in pre-compounding extruder 10 to form pellets. In a separate step, the formed pellets are mixed with, for example, color pigment, through extruders 12 and extruder 14 to form extrudate 15. The extrudate 15 is passed through die 16 and embossing rollers 18 to form a skin 20.

Skin 20 has a color of approximately 80% of the desired color, and thus requires painting. In order to provide the desired appearance, ultra violet stabilization, and scuff and scratch resistance to skin 20, the skin is primed and painted by a painting process 21. A primer 22 is applied to both sides of skin 20 followed by heating in an oven 24. A topcoat of paint 26 is applied over primer 22 on one said of skin 20, followed again by heating in a second oven 28. The primer 22 on the unpainted side is used to increase adhesion with a layer of foam as known in the art. Skin 20 is then transferred to rolls 30 for forming articles therefrom.

In applications where skin 20 is used in a formed article, such as an instrument panel section of a vehicle, the skin is formed into a desired shape. For example, a vacuum forming process is used to form skin 20 into the instrument panel section with a grain or pattern formed therein. The vacuum forming process applies heat to skin 20 that re-heats the skin such that the surface of the skin actually flows and reforms as a smooth surface on a microscopic level. Here, the grain or pattern is not affected by the reforming as a smooth surface, rather skin 20 has a higher gloss. Thus, the smooth surface provides a high gloss to the formed article made from skin 20.

The optical property commonly referred to as gloss is related to the smoothness of the surface of a material on a microscopic level. For example, if one were to examine the surface of glass or some other glossy or shiny surface under a microscope, one would observe a relatively smooth surface. Such a smooth surface is capable of reflecting nearly 100% of incident light hitting its surface. As described above, when skin 20 is heated to a temperature hot enough to be vacuum formed, the surface of the skin actually flows and then cools to a very smooth, high gloss surface.

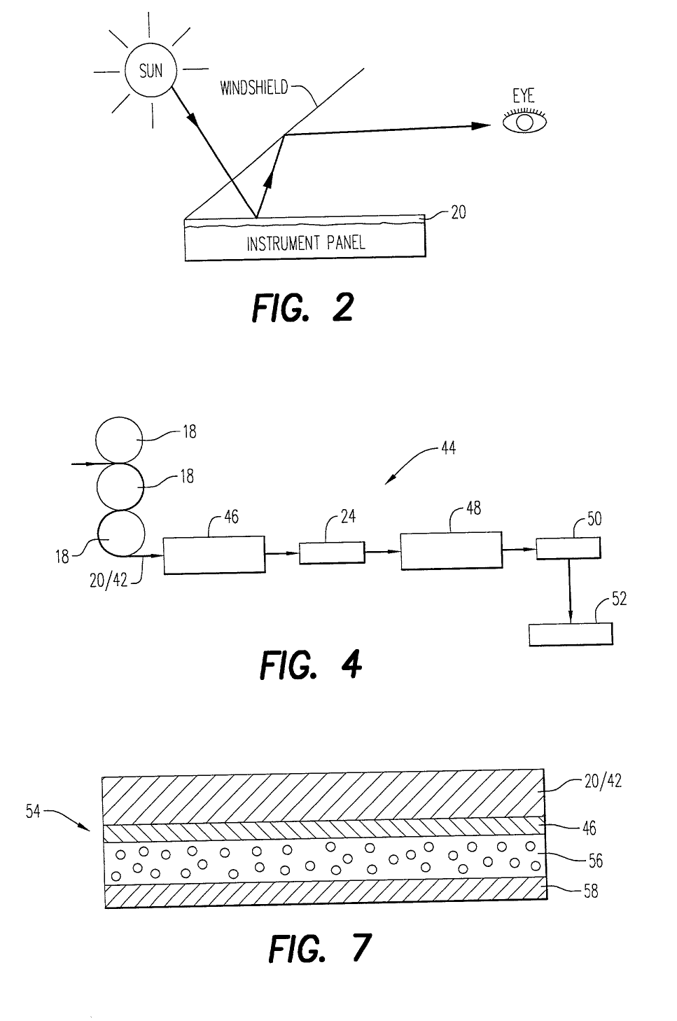

Thus, where the vacuum formed skin 20 is used as an instrument panel of a vehicle, the high gloss of the skin creates a veiling glare as illustrated in FIG. 2. Here, light from outside sources such as the sun is reflected by the skin to the eye of an occupant of the vehicle. This veiling glare is potentially distracting and/or uncomfortable for the occupant.

Accordingly, painting process 21 is necessary to provide the desired appearance, ultra violet stabilization, and scuff and scratch resistance to formed skin 20, and is also necessary to provide the desired reduction in veiling glare when the formed skin is used in an instrument panel. However, painting process 21 is time consuming and expensive with respect to labor, materials, and equipment.

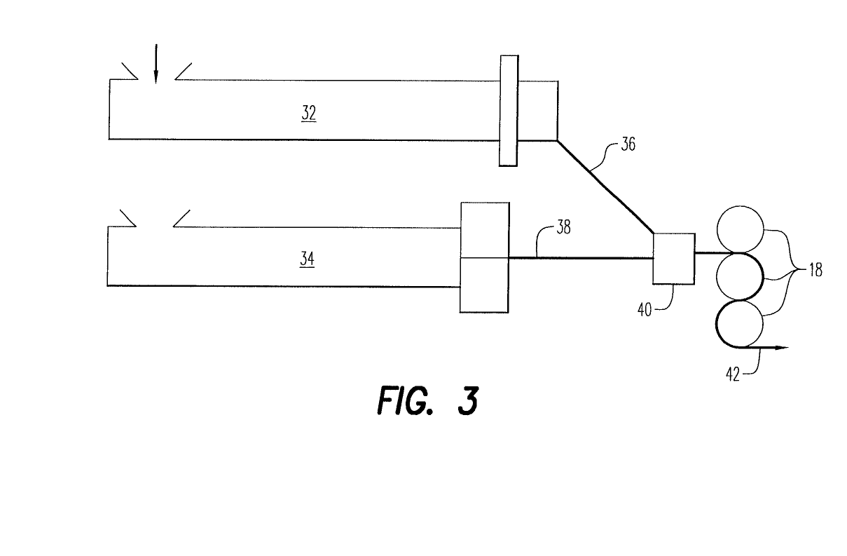

FIG. 3 is a schematic of an alternate manufacturing process. Here, the desired polymers are compounded and co-extruded through extruder 32 and co-extruded through extruder 34 to form extrudate layers 36 and 38, respectively. Layer 36 is a side of skin 20 that is visible to the user, while layer 38 is a side that is not visible to the user. Thus, layer 36 is formed of virgin material having a color of 100% of the desired color, while layer 38 is formed of regrind or recycled material having no additional color added. Layers 36 and 38 are then passed through layer die 40 and through embossing rollers 18 to form skin 42.

As described above, in applications where skin 42 is used as an instrument panel of a vehicle, the skin is formed into a desired shape. Here, the vacuum forming process applies heat to skin 42 that re-heats the materials in the skin such that the surface of the skin actually flows and reforms as a smooth surface on a microscopic level, while maintaining the embossed grain. The smooth surface imparts a higher than desired gloss to the formed skin 42.

Thus, even though skin 42 has a 100% color match, painting with a clear coat of paint 26 is still required to reduce gloss and subsequent veil glare. Thus, skin 42 is provided to painting process 21 as described above with respect to FIG. 1. Namely, primer 22 is applied to both sides of skin 42 and cured in oven 24, clear coat of paint 26 is applied over primer 22 and cured in second oven 28, and the skin is transferred to rolls 30.

It has been determined that gloss in polymer skins such as but not limited to those manufactured by the processes of FIGS. 1 and 3 is reduced by applying a particulate blast to the surface of the polymer material. Blasting the surface with a select particulate material serves to modify the surface of the plastic material enough to result in a reduction in gloss, without notably affecting the visual surface grain of the material.

By treating the surface of skin 20 or 42 with a blast of particulate media, the surface is dented or deformed, on a microscopic level, and these minute deformations serve to reflect light in a myriad of different directions, thus markedly reducing the gloss of the surface. Preferably, gloss is reduced to between about 1.5 to about 3.0 as measured on a 60° scale.

The particular material is a material that when propelled at high velocity to impact the surface serves to effect the surface so as to reduce its light reflecting characteristics, without abrading or damaging the integrity of the surface of skin 20 or 42. Preferred particulate materials include dry ice (i.e., solid carbon dioxide), baking powder, ice, sand, and glass beads.

Referring now to FIG. 4, an exemplary embodiment of a media blasting process 44 of skin 20 or 42 is illustrated. Blasting process 44 replaces painting process 21 described above. Here, a primer 46 is applied to one side of skin 20 or 42 followed by heating in an oven 24. The primer 46, similar to the primer 22 discussed above on the unpainted side of the skin, is used to increase adhesion with a layer of foam as known in the art.

Skin 20 or 42 is then formed into a desired shaped by a vacuum forming process 48. Next, a layer of foam is applied to primer 46 by a foam-in-place process 50. After application of the layer of foam, skin 20 or 42 is transferred to a blaster 52. The unprimed side of skin 20 or 42 is exposed to particles accelerated in and entrained by a stream of air or other inert gas in blaster 52. Blaster 52 accelerates the particles to a speed sufficient to deform the unprimed surface of skin 20 or 42 without damaging the physical integrity of the skin. Thus, blaster 52 removes gloss from skin 20 or 42. Skin 20 or 42 is then assembled.

Thus, blasting process 44 removes at least two manufacture steps from skin 20 or 42, namely the painting 26 and curing 28 steps. Moreover, blasting process 44 eliminates primer 22 from one side of skin 20 or 42.

Particularly preferred for blasting process 44 is a granulated dry ice particulate blasting media or other particle capable of sublimation. Here, particles are used that are solid under normal ambient conditions, but sublime as a gas after blasting the target. Accordingly, there is minimal clean up required to remove the gaseous carbon dioxide after a surface has been blasted with solid carbon dioxide particles. Further, gaseous carbon dioxide only presents a minimal atmospheric pollution problem inasmuch as ambient air contains carbon dioxide and inasmuch as carbon dioxide gas is readily dispersed within ambient air.

Dry ice blasting is a process that has been used for cleaning machine tools, engines, and polymer molding cores and cavities. Here, the dry ice particles are propelled at high velocity to impact the surface of the substrate being treated. Upon impacting the substrate, the particles penetrate a mass (e.g., rust, paint, mold release, slag, and the like) to be cleaned. However, the particles do not pierce the substrate material, but instead impact the surface of the substrate and sublime instantly after contact. This sublimation impact event creates a tension wave that flushes the surface clean of particles of the mass being cleaned.

It has been determined that dry ice blasting is particularly useful in gloss reduction of polymer skins 20 or 42. The dry ice particles leave the desired subtle impressions on the skin's surface (i.e., removing gloss) without damaging the physical integrity of the skin. The subtle impressions serve effectively to reduce light reflection from the skin, thus reducing veiling glare and eliminating the need for painting or clear coating. It should be recognized that particulates other than dry ice such as baking powder, ice, sand, and glass beads, which leave subtle impressions on the skin's surface without damaging the physical integrity of the skin, are considered within the scope of the present invention.

Typically, the dry ice particles used as particulate in the present process have a particle size ranging from about 5 microns to 40 microns. A preferred particle size is about 10 microns to 30 microns. The particles generally are propelled using air at a pressure ranging from about 40 psi to about 150 psi through a nozzle to accelerate the particles to a speed sufficient to deform the skin's surface without damaging the physical integrity of the skin.

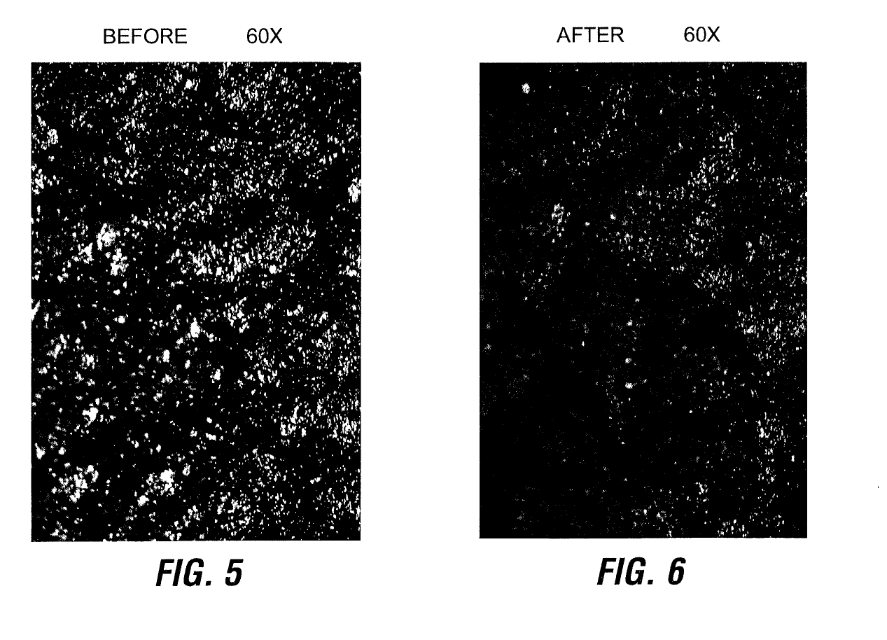

Referring now to FIGS. 5 and 6, a comparison of the smoothness, and therefore gloss levels, is provided by a photomicrograph of the surface of skin 20 or 42 at 60× magnification prior media blasting process 44 and after the media blasting process. Preferably, media-blasting process 44 provides skin 20 or 42 with a gloss of less than about 3.0 as measured using polyolefin plaques at a 60° scale. More preferably, process 44 provides skin 20 or 42 with a gloss of about 2.2 as measured using the polyolefin plaques.

Of course and as applications may require measuring gloss is accomplished by methods other than the aforementioned polyolefin plaques at the 60° scale such as those described in the American Society for Testing and Materials (ASTM) tests D5767 and D523.

Three examples of skin 20 or 42 prior to media blasting process 44 were sampled. Here, skin 20 or 42 prior to media blasting process 44 had a gloss of 3.2, 4.5 and 6.0, respectively. However, after exposure of skin 20 or 42 prior to media blasting process 44, the gloss was reduced to 2.2, 2.5 and 2.5, respectively.

It has also been found that media blasting process 44 narrows the gloss range of skin 20 or 42 as compared to painted skins. For example, skins 20 or 42 under going painting process 21 typically have a gloss that ranges ±1.0. However, skins 20 or 42 under going media blasting process 44 typically have a gloss that ranges ±0.3. Thus, it has been found that media blasting process 44 provides skin 20 or 42 with a more consistent gloss level than previously available.

Of course, and as applications may require, blasting process 44 providing skin 20 or 42 with no primer 46 is considered within the scope of the invention. Moreover, it is considered within the scope of the invention for blasting process 44 to expose both sides skin 20 or 42 to blaster 48. In this example, the varying levels of deformation for the sides of skin 20 or 42 are considered within the scope of the present invention. For example in the manufacture of instrument panels, the side of skin 20 or 42 not visible to the user often has a layer of foam adhered thereto. Increasing the level of deformation by blaster 48 to the side of skin 20 or 42 where the layer of foam is to be adhered beyond mere gloss reduction is useful in increasing adhesion between the skin and the foam.

Referring now to FIG. 7, an instrument panel section 54 is illustrated. Instrument panel section 54 includes skin 20 or 42 and a foam layer 56. As discussed above, skin 20 or 42 includes primer 46 disposed on one side. Foam 56 is adhered to skin 20 or 42 at primer 46. In a preferred embodiment, section 54 further includes a liner 58 adhered to foam 56 opposite skin 20 or 42. Thus when installed in a vehicle, foam 56 provides a layer of resilient padding between skin 20 or 42 and the vehicle's support structures.

The embodiments of the present process, compositions, and articles made therefrom, although primarily described in relation to dry ice blasting and TPE skins intended for utility as instrument panels, can also be utilized with various other particulate materials, for treatment of various surfaces, and in various other applications, such as but not limited to injection molding.

It will be understood by those skilled in the art that modifications to the preferred embodiments shown herein may be made with the scope and intent of the claims. While the present invention has been described as carried out in specific embodiments thereof, it is not intended to be limited thereby but rather to cover the invention broadly within the scope and spirit of the claims.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An unpainted thermoplastic material, comprising:
a microscopically deformed surface having a gloss less than about 3.0.

2. The unpainted thermoplastic material of claim 1, wherein said microscopically deformed surface is formed in the shape of a skin.

3. The unpainted thermoplastic material of claim 2, wherein said skin includes a layer of foam adhered to a second surface opposite said microscopically deformed surface.

4. A method of reducing gloss of a formed thermoplastic material, comprising:
impacting a surface of the formed thermoplastic material with a particulate so as to effect light reflecting properties of said surface.

5. The method of claim 4, wherein said surface is microscopically deformed such that said light reflecting properties provide a gloss of less than about 3.0.

6. The method of claim 4, wherein said particulate is selected from the group consisting of baking powder, ice, sand, glass beads, and subliming particles.

7. The method of claim 6, wherein said subliming particles are solid carbon dioxide particles.

8. A method of making a plastic article, comprising:
forming an extrudate of thermoplastic material;
forming the plastic article from said extrudate; and
microscopically deforming a surface of the plastic article to reduce a gloss level of said surface.

9. The method of claim 8, wherein said gloss level is less than about 3.0.

10. The method of claim 8, wherein microscopically deforming said surface comprises:
exposing said surface to particles accelerated in and entrained by a stream of air or other inert gas.

11. The method of claim 10, wherein said particles are selected from the group consisting of baking powder, ice, sand, glass beads, and subliming particles.

12. The method of claim 11, wherein said subliming particles are solid carbon dioxide particles.

13. The method of claim 8, wherein forming said extrudate of thermoplastic material comprises:
extruding a first layer of virgin thermoplastic material having a color of 100% of a desired color;
extruding a second layer of regrind or recycled thermoplastic material; and
forming a skin from said first layer and said second layer, said skin having a first side of said first layer and a second side of said second layer, said first side being said surface.

14. The method of claim 13, wherein forming the plastic article from said extrudate further comprises:
vacuum forming said skin into a desired shape.

15. The method of claim 14, wherein forming the plastic article from said extrudate further comprises:
priming said second side; and
adhering a layer of foam to said second side.

16. The method of claim 15, wherein microscopically deforming said surface comprises:
exposing said surface to particles accelerated in and entrained by a stream of air or other inert gas.

17. The method of claim 10, wherein said particles are selected from the group consisting of baking powder, ice, sand, glass beads, and subliming particles.

18. An instrument panel section, comprising:
a skin of unpainted thermoformed thermoplastic material.

19. The instrument panel section of claim 18, wherein said skin includes a first surface having a gloss less than about 3.0.

20. The instrument panel section of claim 19, further comprising a layer of foam, said layer of foam being adhered to a second surface of said skin.

21. The instrument panel section of claim 18, wherein said gloss of said first surface is provided by a plurality of microscopic deformations or dents on said first surface.

22. The instrument panel section of claim 19, wherein said skin has a desired color at least on said first surface.
